(19) United States
(12) Patent Application Publication
(10) Pub. No.: US 2026/0177767 A1
(43) Pub. Date: Jun. 25, 2026

(54) RETENTION MECHANISM

(71) Applicant: ALL RING TECH CO., LTD., Kaohsiung City (TW)

(72) Inventors: Chun-Hung TSAI, Kaohsiung City (TW); Heng-Hui LIU, Kaohsiung City (TW); Yu-Sheng GUO, Kaohsiung City (TW); Li-Hsin CHEN, Kaohsiung City (TW)

(21) Appl. No.: 19/395,719

(22) Filed: Nov. 20, 2025

(30) Foreign Application Priority Data
Dec. 20, 2024 (TW) 113150069
Apr. 2, 2025 (TW) 114112786

(51) Int. Cl. G02B 6/42

(52) U.S. Cl. CPC G02B 6/424; G02B 6/4212; G02B 6/423; G02B 6/4249

(57) ABSTRACT

A retention mechanism adapted for retaining an optical fiber array unit is provided. The retention mechanism includes a retention unit and a connector unit. The retention unit includes a retention member adapted for retaining the optical fiber array unit. The connector unit includes a connector member adapted to be electrically connected to a measurement unit, movable relative to the retention member, and adapted to be detachably connected to the optical fiber array unit.

### CROSS-REFERENCE TO RELATED APPLICATION

This application claims priority to Taiwanese Invention Patent Application No. 113150069, filed on Dec. 20, 2024, and Taiwanese Invention Patent Application No. 114112786, filed on Apr. 2, 2025, the entire disclosures of which are incorporated by reference herein.

### FIELD

The disclosure relates to a retention mechanism, and more particularly to a retention mechanism and a component retention method for retaining an optical fiber array unit.

### BACKGROUND

In a semiconductor manufacturing process, in order to produce chips that have relatively high transmission performance and relatively low power consumption, silicon photonics (SiPh) technology has become the focus of industry development. In silicon photonics technology, such as a pluggable transceiver optics (PTO) infrastructure, an on-board optics (OBO) infrastructure, a co-packaged optics (CPO) infrastructure and an optical input/output (optical I/O) infrastructure, it is necessary to couple a fiber array unit (FAU) to an integrated circuit component.

Currently, the process of integrated circuit component packaging has progressed to two-point-five dimensional (2.5D) IC packaging and three-dimensional (3D) IC packaging, and integrated circuit components and fiber optic array units have also been modified in structure with the advancement of the process of integrated circuit component packaging. For example, the integrated circuit component includes photonic integrated circuits (PIC), and the optical fiber array unit includes optical couplers, receptacle portions and optical fibers that are connected between the optical couplers and the receptacle portions. The photonic integrated circuits of the integrated circuit component are coupled to the optical couplers of the optical fiber array unit and are in optical communication with the external environment through the optical fibers of the optical fiber array unit.

When operations for coupling the optical fiber array unit to the integrated circuit component are performed, it is necessary to retain the optical fiber array unit with a conventional retention mechanism. However, retaining the optical fiber array unit only with a clamp or a suction cup is not stable and reliable, and the optical fiber array unit may easily fall off from the conventional retention mechanism. Furthermore, before the conventional retention mechanism retains the optical fiber array unit, cumbersome optical measurement of the optical fiber array unit must be performed.

### SUMMARY

Therefore, an object of the present disclosure is to provide a retention mechanism that can alleviate at least one of the drawbacks of the prior art.

According to an aspect of the disclosure, a retention mechanism adapted for retaining an optical fiber array unit is provided. The retention mechanism includes a retention unit and a connector unit. The retention unit includes a retention member adapted for retaining the optical fiber array unit. The connector unit includes a connector member adapted to be electrically connected to a measurement unit, movable relative to the retention member, and adapted to be detachably connected to the optical fiber array unit.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary perspective view of an integrated circuit component and an optical fiber array unit to be coupled to an integrated circuit component.

FIG. 2 is a fragmentary schematic sectional view illustrating the optical fiber array unit coupled to the integrated circuit component.

FIG. 3 is a perspective view of the optical fiber array unit.

FIG. 4 is a perspective view of the optical fiber array unit seen from an angle different from FIG. 3.

FIG. 5 is a perspective view of a retention mechanism of a first embodiment according to the present disclosure adapted for retaining the optical fiber array unit.

FIG. 6 is a partly exploded perspective view of the first embodiment.

FIG. 7 is a fragmentary side view illustrating the first embodiment and the optical fiber array unit.

FIG. 8 is a fragmentary partly exploded perspective view of the first embodiment, illustrating a support frame, a retention unit, a connector unit, and a drive unit of the first embodiment.

FIG. 9 is an exploded perspective view of a retention member and a limit assembly of the retention unit of the first embodiment.

FIG. 10 is a fragmentary side view illustrating a first retention portion and a second retention portion of the retention member of the first embodiment.

FIG. 11 is a fragmentary perspective view illustrating the retention member of the first embodiment that is disposed upside down.

FIG. 12 is a partly exploded perspective view of the connector unit of the first embodiment.

FIG. 13 is a perspective view of a mount seat of the connector unit of the first embodiment seen from an angle different from FIG. 12.

FIG. 14 is a schematic front view of the connector unit of the first embodiment.

FIG. 15 is a fragmentary exploded perspective view of a connector member and a movable seat of the connector unit of the first embodiment.

FIG. 16 is a fragmentary side view of the first embodiment, illustrating the retention member retaining the optical fiber array unit, and the connector member not connected to the optical fiber array unit.

FIG. 17 is a view similar to FIG. 16, but illustrating the connector member being connected to the optical fiber array unit.

FIG. 18 is a fragmentary schematic sectional view illustrating a cure unit of the first embodiment emitting ultra violet and laser light or hot air flow toward the optical fiber array unit to respectively cure a first adhesive and a second adhesive.

FIG. 19 is a perspective view of the retention mechanism of the first embodiment being mounted to a component coupling device.

FIG. 20 is a flow chart of a component retention method implemented by the retention mechanism of the first embodiment.

FIG. 21 is a perspective view of a retention mechanism of a second embodiment according to the present disclosure.

FIG. 22 is a partly exploded perspective view of the retention mechanism of the second embodiment.

FIG. 23 is a fragmentary side view illustrating the retention mechanism of the second embodiment.

FIG. 24 is a fragmentary side view illustrating the first retention portion and the second retention portion of the retention member of the retention mechanism of the second embodiment.

FIG. 25 is a fragmentary perspective view illustrating the retention member of the second embodiment that is disposed upside down.

FIG. 26 is a perspective view illustrating the drive unit and the connector unit of the retention mechanism of the second embodiment.

FIG. 27 is a partly exploded perspective view illustrating the connector unit of the retention mechanism of the second embodiment.

FIG. 28 is a fragmentary exploded perspective view of the connector member and the movable seat of the connector unit of the retention mechanism of the second embodiment.

FIG. 29 is a schematic side view, illustrating the connector member being detachably connected to the optical fiber array unit.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

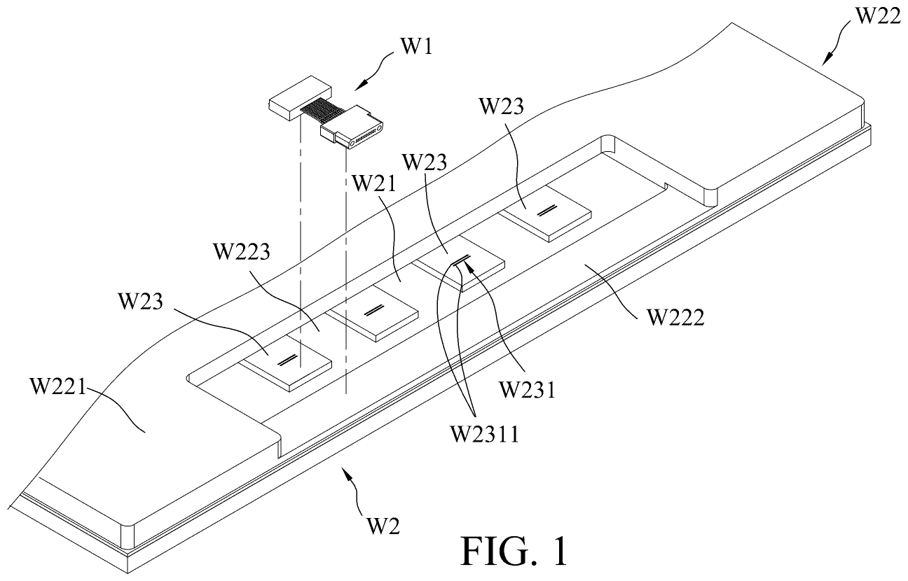

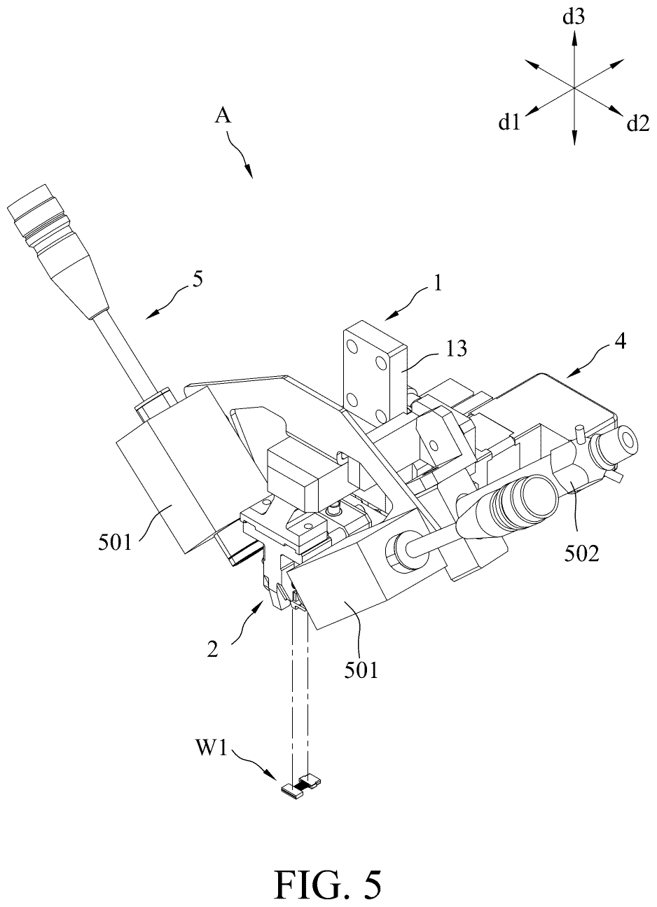

Referring to FIGS. 1 to 5, a retention mechanism (A) (see FIG. 5) of a first embodiment according to the present disclosure is adapted for retaining an optical fiber array unit (W1) that is to be coupled to an integrated circuit component (W2).

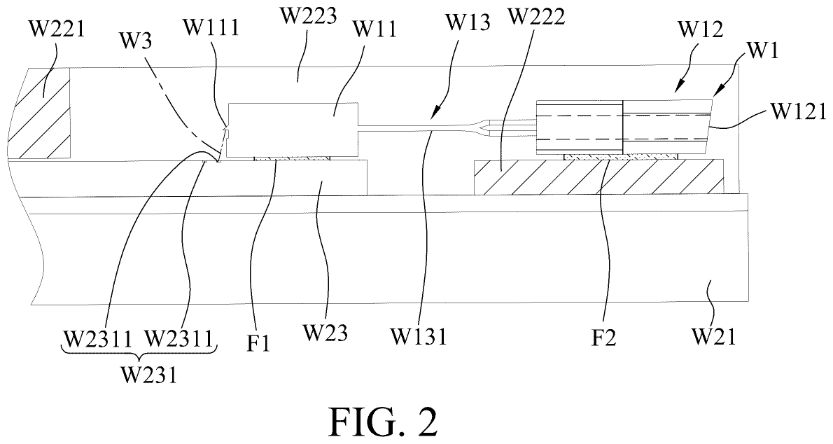

As shown in FIGS. 2 to 4, the optical fiber array unit (W1) includes an optical coupler (W11), a receptacle portion (W12), and an optical fiber portion (W13) connected between the optical coupler (W11) and the receptacle portion (W12). The optical coupler (W11) and the receptacle portion (W12) are spaced apart from each other. The optical coupler (W11) is made of a light-transmissive material, and includes a prism (W111) that is formed on a first side surface (W112) of the optical coupler (W11) which is distal from the receptacle portion (W12). The receptacle portion (W12) is provided for the optical fiber portion (W13) to extend therethrough such that the optical fiber portion (W13) is exposed outwardly from a second side surface (W121) of the receptacle portion (W12) that is distal from the optical coupler (W11). The receptacle portion (W12) includes a first seat portion (W122), a second seat portion (W123) having a width smaller than a width of the first seat portion (W122) in a direction transverse to a direction that the optical fiber portion (W13) extends in, and two guide holes (W124) extending through the first seat portion (W122) and the second seat portion (W123). As shown in FIG. 2, the second side surface (W121) of the receptacle portion (W12) is tilted outwardly from bottom to top. The optical fiber portion (W13) includes a plurality of optical fibers (W131) connected to the optical coupler (W11) and the receptacle portion (W12), extend in a direction the same as a direction that the guide holes (W124) extend in, and are flexible.

Referring back to FIGS. 1 and 2, the integrated circuit component (W2) includes a carrier (W21), a cover unit (W22), and at least one photonic integrated circuit (W23) disposed on the carrier (W21). In this embodiment, a plurality of photonic integrated circuits (W23) are disposed on the carrier (W21) and are arranged on one side of the carrier (W21). The cover unit (W22) includes a first cover portion (W221), a second cover portion (W222) that is lower in height than the first cover portion (W221), and a recessed portion (W223) that is disposed between the first cover portion (W221) and the second cover portion (W222) and that exposes the photonic integrated circuits (W23) therefrom.

In some embodiments, the recessed portion (W223) is formed according to a design of positions of the photonic integrated circuits (W23) and is not limited to the above example. For example, in some embodiments, the recessed portions (W223) are disposed adjacent to four sides of the carrier (W21) that is rectangular. Each of the photonic integrated circuits (W23) includes a lens array (W231) that includes a plurality of lenses (W2311) that are arranged as a matrix. Two of the lenses (W2311) are shown in FIG. 2. It should be noted that since the structures of the photonic integrated circuits (W23) are the same, only one of the photonic integrated circuits (W23) will be described in the following description for the sake of brevity.

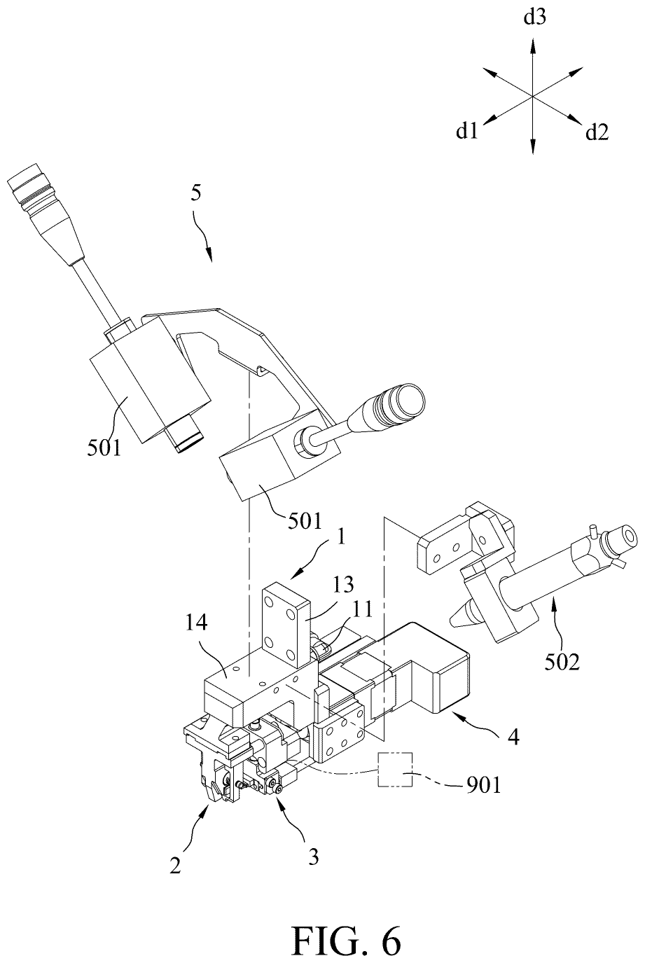

When the optical fiber array unit (W1) is coupled to the photonic integrated circuit (W23) of the integrated circuit component (W2), the optical coupler (W11) of the optical fiber array unit (W1) is in contact with and abuts against the photonic integrated circuit (W23) via adhesive and the receptacle portion (W12) is in contact with the second cover portion (W222) of the cover unit (W22) via adhesive. The prism (W111) of the optical coupler (W11) of the optical fiber array unit (W1) is disposed to correspond in position to the lenses (W2311) of the lens array (W231) of the photonic integrated circuit (W23) such that an optical signal (W3) (see FIG. 2) may be transmitted between the prism (W111) of the optical fiber array unit (W1) and the lens array (W231) of the photonic integrated circuit (W23). In this embodiment, the optical signal (W3) is outputted from a measurement unit 901 (see FIG. 6), is transmitted to the optical fiber array unit (W1), is transmitted into the photonic integrated circuit (W23) from the optical fiber array unit (W1), and is transmitted back to the optical fiber array unit (W1) from the photonic integrated circuit (W23), sequentially. The measurement unit 901 is for measuring an intensity of the optical signal (W3) transmitted back to the optical fiber array unit (W1). The optical coupler (W11) and the photonic integrated circuit (W23) may be connected to each other by a first adhesive (F1), and the receptacle portion (W12) and the second cover portion (W222) may be connected to each other by a second adhesive (F2). In this embodiment, the first adhesive (F1) is an ultraviolet cured adhesive and the second adhesive (F2) is a heat cured adhesive.

It should be noted that, in other embodiments of the present disclosure, the second cover portion (W222) may be omitted and the cover unit (W22) may only include the first cover portion (W221), so that the receptacle portion (W12) is in contact with and abuts against the carrier (W21).

Referring to FIGS. 5 to 7, the retention mechanism (A) of the first embodiment of the present disclosure is adapted for retaining the optical fiber array unit (W1). In this embodiment, in the following description, a first direction (d1) is a transverse direction, a second direction (d2) is another transverse direction normal to the first direction (d1), and a third direction (d3) is a vertical direction normal to the first direction (d1) and the second direction (d2). In this embodiment, the first direction (d1) is a front-rear direction, the second direction (d2) is a left-right direction, and the third direction (d3) is an up-down direction.

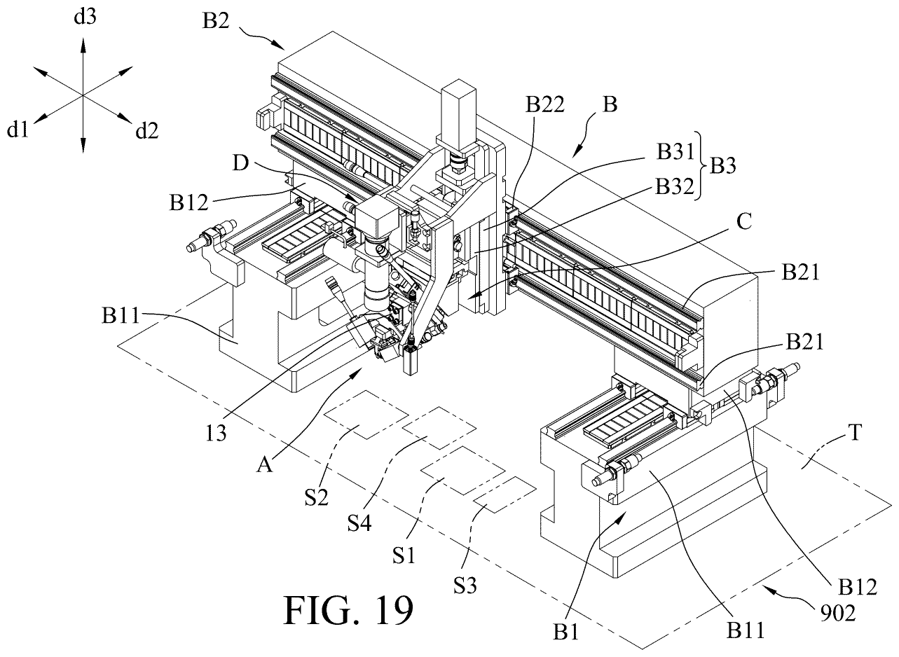

The retention mechanism (A) includes a support frame 1 that is to be mounted to a component coupling device 902 (see FIG. 19), a retention unit 2 mounted on the support frame 1 and adapted for retaining the optical fiber array unit (W1), a connector unit 3 mounted to the support frame 1 and connected to the measurement unit 901, a drive unit 4 mounted to the support frame 1 and operable to drive the connector unit 3 to move in the first direction (d1), and a cure unit 5 disposed on the support frame 1 and adapted to cure the first adhesive (F1) and the second adhesive (F2). The support frame 1 is movable and is driven to move the retention unit 2 and the connector unit 3.

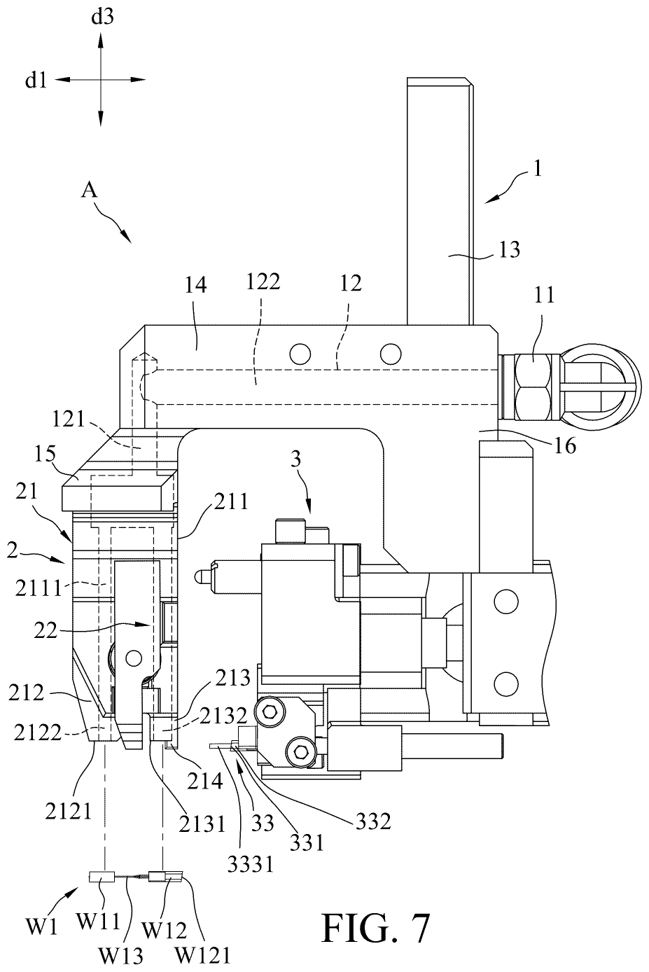

Referring to FIGS. 6 to 8, the support frame 1 is formed with an air passage 12 (see FIG. 7) in fluid communication with a valve 11. The valve 11 is in fluid communication with a negative pressure source (not shown). Specifically, the support frame 1 includes a rectangular body 13 that is substantially upright in the third direction (d3) and that is mounted to the component coupling device 902 (see FIG. 19), a main body 14 that is connected to a bottom side of the rectangular body 13 and that extends in the first direction (d1), a first mounting portion 15 that extends downwardly from a front portion of the main body 14, a second mounting portion 16 that extends downwardly in the third direction (d3) from a rear portion of the main body 14 that is opposite to the front portion in the first direction (d1), and the air passage 12 that is formed in the main body 14 and the first mounting portion 15. The air passage 12 includes a first air passage segment 121 extending upwardly from a bottom surface of the first mounting portion 15 to the front portion of the main body 14, and a second air passage segment 122 in spatial communication with the first air passage segment 121 and extending from the front portion of the main body 14 to the rear portion of the main body 14. The valve 11 is in spatial communication with the second air passage segment 122 and the negative pressure source.

As shown in FIGS. 5 and 19, since the retention unit 2, the connector unit 3, and the drive unit 4 are all mounted to the support frame 1 and the support frame 1 is mounted to and driven by the component coupling device 902 to move, the retention unit 2 and the connector unit 3 are co-movable with the support frame 1 when the support frame 1 is moved by the component coupling device 902. The term “move” described in this disclosure may refer to a linear movement, a rotation, a swing movement, and/or a pivot movement.

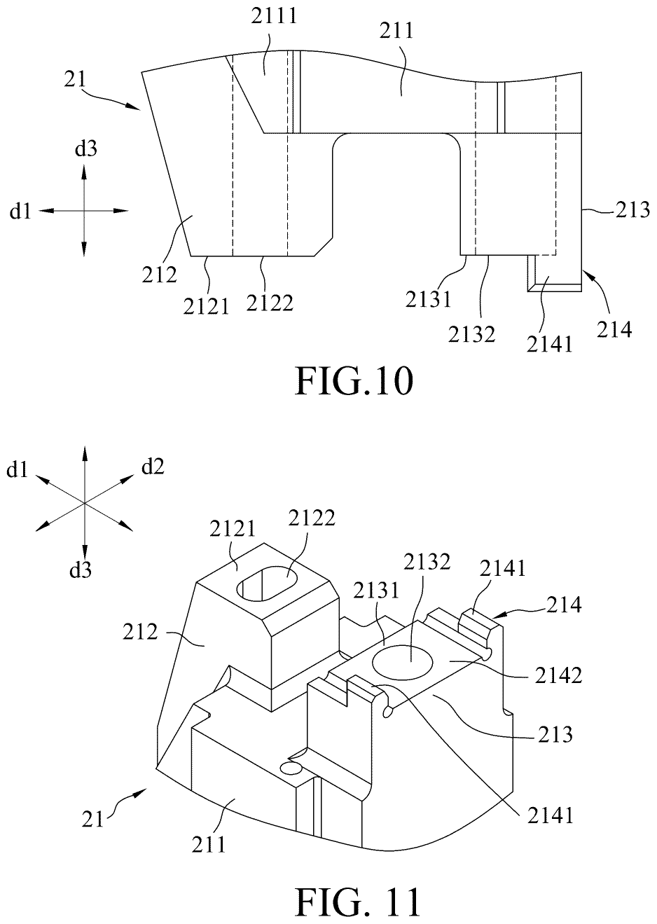

Referring to FIGS. 6 to 10, the retention unit 2 includes a retention member 21 and a limit assembly 22 mounted to and movable relative to the retention member 21. The retention member 21 includes a main body 211 that is substantially T-shaped and that is connected to a bottom side of the first mounting portion 15, a first retention portion 212 that extends downwardly in the third direction (d3) from a front portion of the main body 211, a second retention portion 213 that is spaced apart from the first retention portion 212 in the first direction (d1) and that extends downwardly from a rear portion of the main body 211 that is opposite to the front portion of the main body 211 in the first direction (d1), and a limit portion 214 that is mounted to the second retention portion 213. The first retention portion 212 and the second retention portion 213 are adapted for retaining the optical coupler (W11) and the receptacle portion (W12) of the optical fiber array unit (W1), respectively.

As shown in FIGS. 7, 9, and 10, the first retention portion 212 has a first retention surface 2121 disposed at a bottom side thereof and facing downwardly, and a first negative pressure hole 2122 formed through the first retention surface 2121. The first retention surface 2121 is adapted to be in contact with the optical coupler (W11) of the optical fiber array unit (W1) for picking up the optical coupler (W11) through the first negative pressure hole 2122. Specifically, the first negative pressure hole 2122 extends upwardly from the first retention surface 2121 in the third direction (d3) and is in spatial communication with the first air passage segment 121. The second retention portion 213 is disposed behind the first retention portion 212 in the first direction (d1) and has a second retention surface 2131 disposed at a lower side thereof and facing downward, and a second negative pressure hole 2132 formed through the second retention surface 2131. The second retention surface 2131 is adapted to be in contact with the receptacle portion (W12) of the optical fiber array unit (W1) for picking up the receptacle portion (W12) through the second negative pressure hole 2132. Specifically, the second negative pressure hole 2132 extends upwardly from the second retention surface 2131 in the third direction (d3) and is in spatial communication with the first air passage segment 121. In this embodiment, the main body 211 of the retention member 21 has a through channel 2111 extending in the third direction (d3) and in spatial communication directly with a bottom side of the first air passage segment 121, an upper portion of the first negative pressure hole 2122, and an upper portion of the second negative pressure hole 2132.

In this way, the first negative pressure hole 2122 and the second negative pressure hole 2132 are both in spatial communication with the valve 11, and thus in spatial communication with the negative pressure source. When the negative pressure source is activated, on the one hand, air is extracted outwardly from the air passage 12, the through channel 2111 and the first negative pressure hole 2122, such that the optical coupler (W11) of the optical fiber array unit (W1) is picked up and retained by the first retention surface 2121 through the first negative pressure hole 2122. On the other hand, air is also extracted outwardly from the air passage 12, the through channel 2111 and the second negative pressure hole 2132, such that the receptacle portion (W12) of the optical fiber array unit (W1) is picked up and retained by the second retention surface 2131 through the second negative pressure hole 2132.

In this way, the first retention portion 212 may retain the optical coupler (W11) of the optical fiber array unit (W1), and the second retention portion 213 may retain the receptacle portion (W12) of the optical fiber array unit (W1). Thus, the retention member 21 may retain the optical fiber array unit (W1) at its both ends in a relatively stable manner to thereby reduce a possibility of the optical fiber array unit (W1) falling off from the retention mechanism (A).

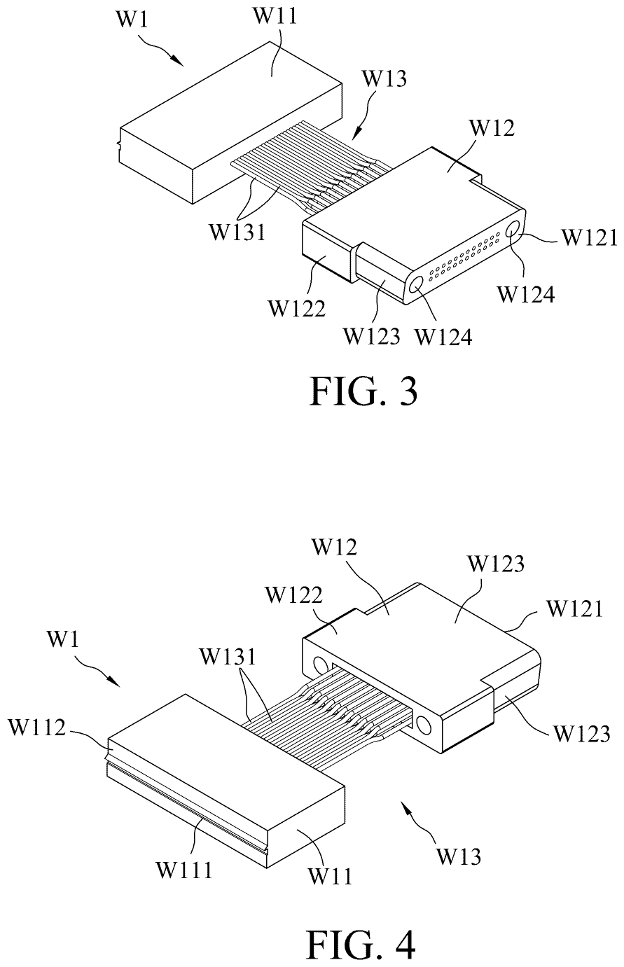

Referring to FIGS. 3, 10, and 11, the limit portion 214 is adapted for limiting movement of the receptacle portion (W12) of the optical fiber array unit (W1), is disposed on one side of the second retention portion 213 that is away from the first retention portion 212 in the first direction (d1), and has two limiting segments 2141. The limiting segments 2141 extend respectively and downwardly from two sides of the second retention surface 2131 that are opposite in the second direction (d2), and are configured as two ribs extending in the first direction (d1). Each of the limiting segments 2141 has a length in the first direction (d1) that is smaller than the length of the second retention surface 2131 in the first direction (d1). The retention member 21 has an accommodation region 2142 that is defined by the limit portion 214, that is a space formed between the limiting segments 2141, and that is adapted for the second seat portion (W123) of the receptacle portion (W12) of the optical fiber array unit (W1) to extend therethrough in the first direction (d1). When the optical fiber array unit (W1) is subjected to a rearward push or pull force, the first seat portion (W122) of the receptacle portion (W12), which is wider in the second direction (d2) than the second seat portion (W123), is blocked by the limiting segments 2141, and thus movement of the optical fiber array unit (W1) in the first direction (d1) is limited.

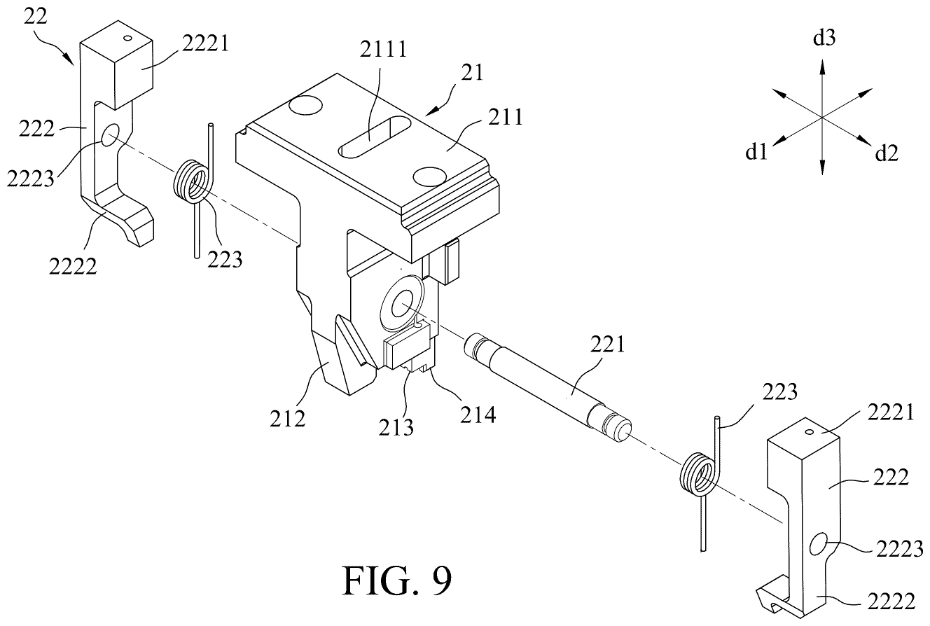

Referring to FIGS. 9, 16, and 17, the limit assembly 22 has a pivot shaft 221 that is rotatable and that extends through the retention member 21, two limit members 222 that are connected respectively to two end portions of the pivot shaft 221 opposite in the second direction (d2), and two biasing members 223 that are mounted respectively to the limit members 222. The limit members 222 are disposed respectively at left and right sides of the retention member 21 in the second direction (d2). Each of the limit members 222 has a driven end 2221, a limit end 2222 which is opposite to the driven end 2221 in the third direction (d3), and a pivot point 2223 which is disposed between the driven end 2221 and the limit end 2222 and into which the respective one of the two end portions of the pivot shaft 221 extends. That is to say, the pivot shaft 221 extends through the main body 211 of the retention member 21 and the two end portions of the pivot shaft 221 are connected to the pivot points 2223 of the limit members 222, such that the limit members 222 are pivotable about the pivot shaft 221. It should be noted that in the following description, since the structures of the limit members 222 are identical and the structures of the biasing members 223 are identical, only one of the limit members 222 and the respective one of the biasing members 223 will be described for the sake of brevity. The driven end 2221 is disposed at an upper portion of the limit member 222 and the limit end 2222 is disposed at a lower portion of the limit member 222. The limit end 2222 is movable relative to the limit portion 214 and is spaced apart from a front portion of the limit portion 214 in the first direction (d1). In this way, when the driven end 2221 of the limit member 222 is subjected to a forward force and pivots forwardly, the limit end 2222 pivots rearwardly. The biasing member 223 is sleeved on the respective one of the end portions of the pivot shaft 221 and is disposed between the retention member 21 and the limit member 222. In this embodiment, the biasing member 223 is a torsion spring that provides an elastic restoring force to move the limit member 222 to its original position when the driven end 2221 is driven to pivot.

In some embodiments, the limit assembly 22 may have only one limit member 222 and the number of each of the limit end 2222, the driven end 2221, and the pivot point 2223 is one.

When the limit member 222 is driven to pivot about the pivot shaft 221 at the pivot point 2223, the limit end 2222 moves rearwardly toward the limit portion 214 to a position where the limit end 2222 is spaced apart from a front surface of the limit portion 214, the limit end 2222 cooperates with the limit portion 214 to limit the movement of the first seat portion (W122) of the receptacle portion (W12), and thus limit the movement of the optical fiber array unit (W1) in the first direction (d1) while the first seat portion (W122) of the receptacle portion (W12) of the optical fiber array unit (W1) is disposed between the limit end 2222 and the limit portion 214.

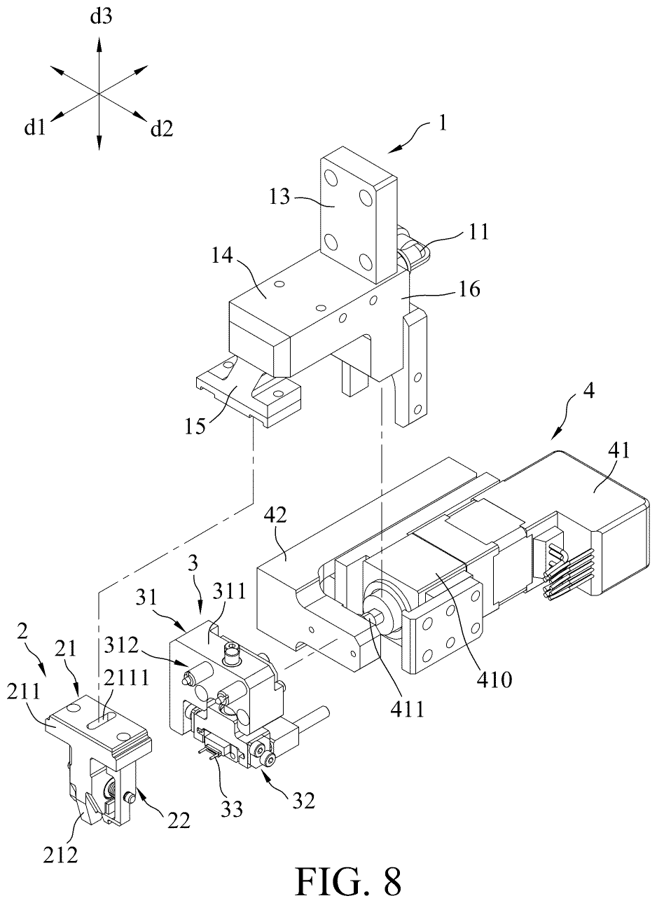

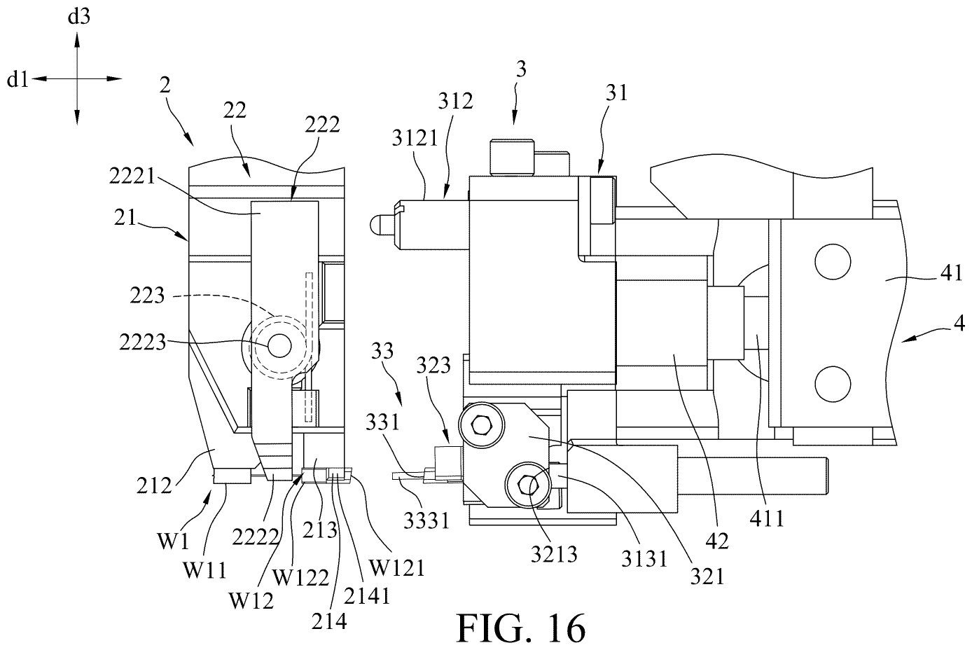

Referring to FIGS. 8 and 16, the drive unit 4 includes a drive member 41 that is connected to the second mounting portion 16 of the support frame 1 and that is generally inverted U-shaped in a top view, and a movable member 42 that is driven by the drive member 41 to move relative to the drive member 41 and the retention unit 2 in the first direction (d1). The drive member 41 may be, but is not limited to, a motor, a pneumatic cylinder, or a hydraulic cylinder. In this embodiment, the drive member 41 includes a driving body 410 and a telescopic rod 411 connected to the driving body 410 and driven thereby to extend and retract in the first direction (d1). In this embodiment, the driving body 410 is a motor, and the telescopic rod 411 is a motor-driven screw rod. The movable member 42 is generally inverted L-shaped in a top view, is connected to a front portion of the telescopic rod 411, and has a lengthwise segment extending rearwardly in the first direction (d1) along a left side of the drive member 41 in the second direction (d2). In this way, the movable member 42 is driven by the drive member 41 to move relative to the drive member 41 in the first direction (d1). It should be noted that the drive member 41 may be an electric cylinder or a slide cylinder, and the movable member 42 is also driven thereby to move linearly in the first direction (d1).

Referring to FIGS. 8 and 12 to 15, the connector unit 3 is mounted to the movable member 42 and is co-movable therewith. In this embodiment, the connector unit 3 includes a mount seat 31 connected to the movable member 42, a movable seat 32 mounted to the mount seat 31 and movable relative to the mount seat 31 along a longitudinal axis extending in the third direction (d3), and a connector member 33 mounted securely to a lower portion of the movable seat 32, movable relative to the retention member 2, adapted to be detachably connected to the optical fiber array unit (W1) (see FIG. 5), and adapted to be electrically connected to the measurement unit 901 (see FIG. 6).

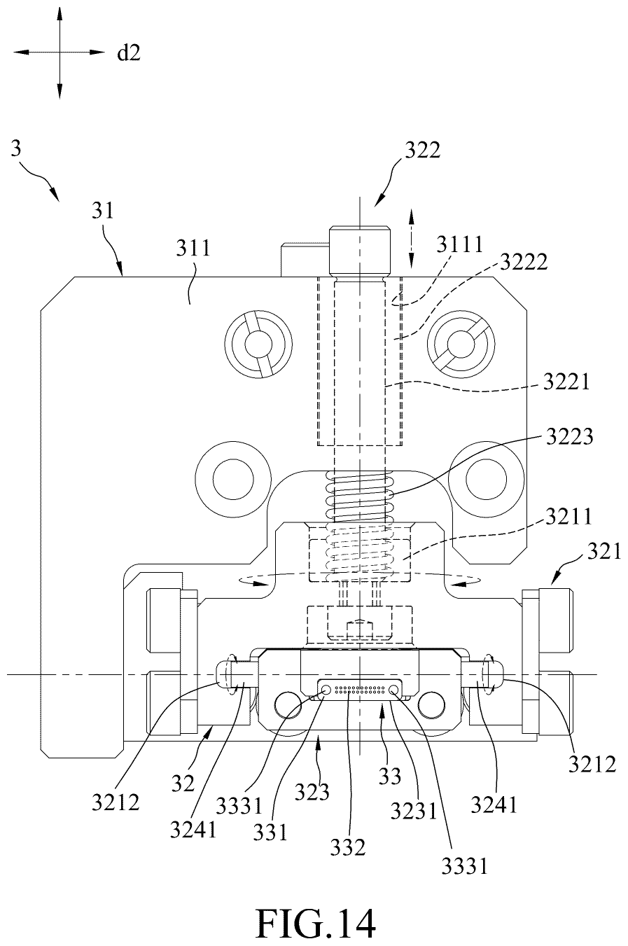

The mount seat 31 includes a main body 311 mounted securely to a front side of the movable member 42, a push assembly 312 mounted to a upper portion of the main body 311, and an abutment assembly 313 mounted to a lower portion of the main body 311. As shown in FIG. 14, the main body 311 is formed with an installation channel 3111 extending in the third direction (d3). The push assembly 312 includes two push members 3121 spaced apart from each other in the second direction (d2) and protruding forwardly in the first direction (d1) from a front surface of the main body 311. Referring to FIG. 16, when the mount seat 31 is driven by the movable member 42 of the drive unit 4 to move forwardly relative to the retention unit 2, the push members 3121 of the push assembly 312 respectively push the driven ends 2221 of the limit members 222, such that the driven ends 2221 pivot forwardly in the first direction (d1), and the limit ends 2222 of the limit members 222 pivot rearwardly toward the limit portion 214. In this embodiment, each of the push members 3121 is a spring-loaded positioning column.

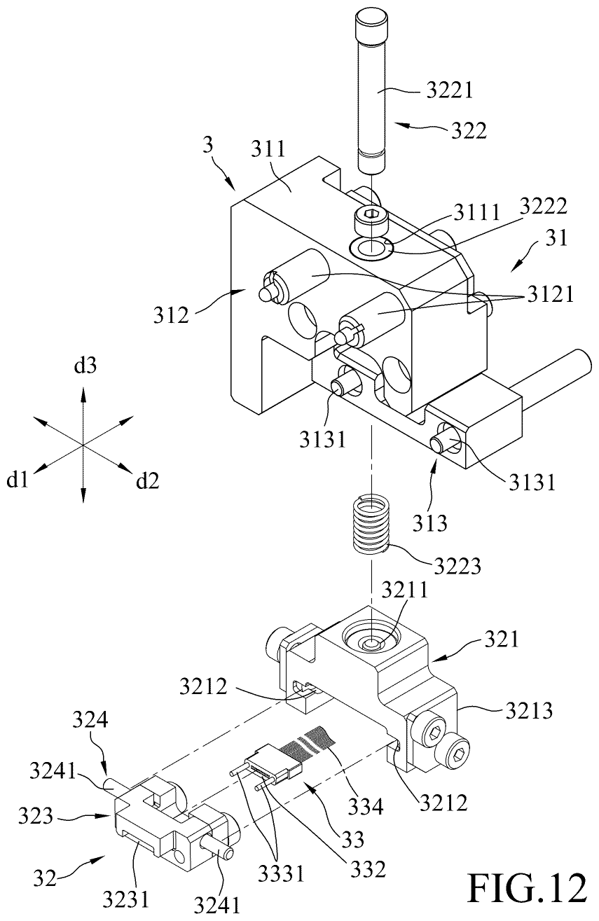

Referring to FIGS. 12 and 16, the abutment assembly 313 includes two abutment members 3131, which are inserted into the bottom of the main body 311 and spaced apart in the second direction (d2). Each abutment member 3131 protrudes from the front and rear surfaces of the main body 311. In this embodiment, each abutment member 3131 is a spring-loaded positioning column.

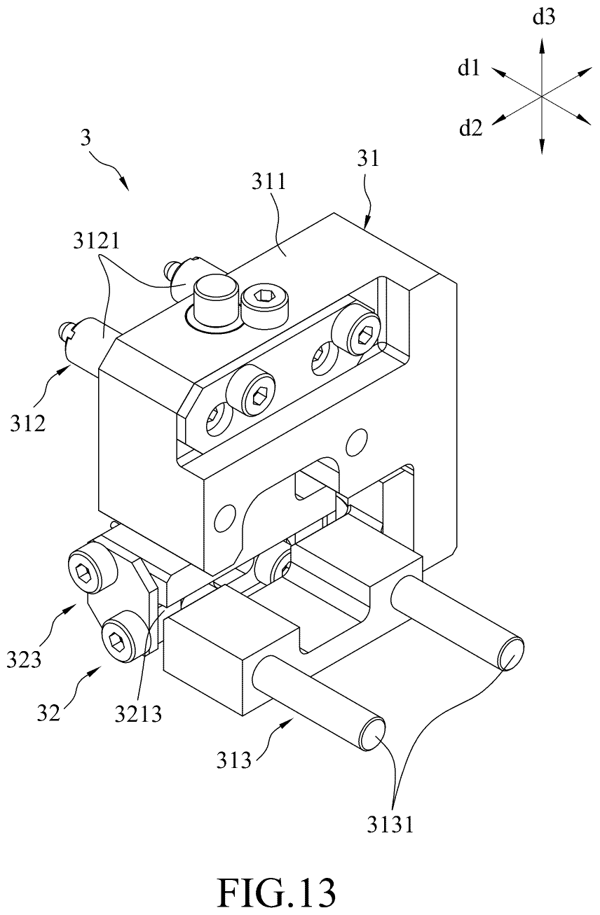

Referring to FIGS. 12 and 14 to 16, the movable seat 32 includes a first seat body 321 connected to the mount seat 31, a first connecting unit 322, a second seat body 323 pivotally mounted to the first seat body 321, and a second connecting unit 324. The first seat body 321 is mounted to a lower portion of the main body 311, is rotatable about the longitudinal axis relative to the mount seat 31, and has a mounting bore 3211 that opens upward, a pushed surface 3213 (see FIGS. 12 and 13) at a rear side thereof, and two pivot slots 3212 that are spaced apart from each other in the second direction (d2). The first connecting unit 322 includes a first axial rod 3221 that is movable in the third direction (d3), that is mounted in the installation channel 3111, and that has a bottom portion exposed outwardly from the mount seat 31 and disposed in the mounting bore 3211, a bushing 3222 securely mounted in the installation channel 3111 and for extension of a top portion of the first axial rod 3221, and a spring member 3223 sleeved on the bottom portion of the first axial rod 3221. The bottom portion of the first axial rod 3221 is connected securely to the first seat body 321. The spring member 3223 has two opposite ends abutting respectively against the main body 311 and the first seat body 321, and may be a compression spring.

The second seat body 323 is mounted to a lower portion of the first seat body 321 and is formed with an accommodation slot 3231 extending in the first direction (d1). The second connecting unit 324 includes two second axial rods 3241 that extend in the second direction (d2), that extend respectively from left and right sides of the second seat body 323, and that pivotally and respectively engage the pivot slots 3212 of the first seat body 321 such that the second seat body 323 is pivotally mounted to the first seat body 321.

Referring to FIGS. 7, 12, 14 and 15, the connector member 33 is mounted in the accommodation slot 3231 of the second seat body 323 and is co-movable with the second seat body 323. The connector member 33 has an abutment surface 331 facing the retention member 21, a light passage portion 332, a guiding portion 333 that may be inserted into the optical fiber array unit (W1), and a light transmission portion 334. The light passage portion 332 and the guiding portion 333 are formed on the abutment surface 331, which is tilted inwardly from the bottom to the top. The guiding portion 333 includes two guide pins 3331 spaced apart from each other in the second direction (d2), extending forwardly from the abutment surface 331 in the first direction (d1), and disposed respectively at left and right sides of the light passage portion 332. The guide pins 3331 are adapted to be respectively inserted into the guide holes (W124) of the receptacle portion (W12) of the optical fiber array unit (W1). The light passage portion 332 is disposed between the guide pins 3331. The light transmission portion 334 is connected between the light passage portion 332 and the measurement unit 901. Further referring to FIG. 3, an inclination degree of the abutment surface 331 is the same as an inclination degree of the second side surface (W121) of the receptacle portion (W12) of the optical fiber array unit (W1). Specifically, the abutment surface 331 and the second side surface (W121) are parallel to and complementary with each other. In this way, when the guide pins 3331 are respectively inserted into the guide holes (W124), the abutment surface 331 abuts against the second side surface (W121) and the light passage portion 332 corresponds in position to the optical fiber portion (W13) of the optical fiber array unit (W1), such that the optical signal (W3) outputted from the measurement unit 901 may be transmitted to the optical fiber array unit (W1).

Referring to FIGS. 12 and 14 to 16, the abutment members 3131 of the abutment assembly 313 abut respectively against left and right portions of the pushed surface 3213 that are opposite in the second direction (d2). By virtue of the first connecting unit 322 that connects the mount seat 31 and the movable seat 32, the first seat body 321 of the movable seat 32 is movable relative to the mount seat 31 in the first direction (d1) and drives the second seat body 323 and the connector member 33 to move therewith. The first seat body 321 is rotatable about the longitudinal axis that is co-axial to the first axial rod 3221 relative to the mount seat 31, and drives the second seat body 323 and the connector member 33 to co-rotate therewith relative to the mount seat 31. In this way, the movable seat 32 and the connector member 33 are movable up and down relative to the mount seat 31 in the first direction (d1), and are rotatable about the first axial rod 3221 relative to the mount seat 31 of the connector member 3. Furthermore, the second seat body 323 is pivotable relative to the first seat body 321 about a transverse axis that is transverse to the first axial rod 3221 and that is co-axial to the second axial rods 3241.

Since the mount seat 31 of the connector unit 3 is connected securely to the movable piece 42 of the drive unit 4, and the movable piece 42 is driven by the drive member 41 to move forwardly and rearwardly in the first direction (d1), the mount seat 31 is also driven by the drive member 41 to move forwardly and rearwardly in the first direction (d1) relative to the retention member 21, such that the connector member 33 is detachably connected to the optical fiber array unit (W1). Specifically, the connector member 33 is moved forwardly to be connected to the optical fiber array unit (W1). On the other hand, the connector member 33 is moved rearwardly to be detached and disengage from the optical fiber array unit (W1).

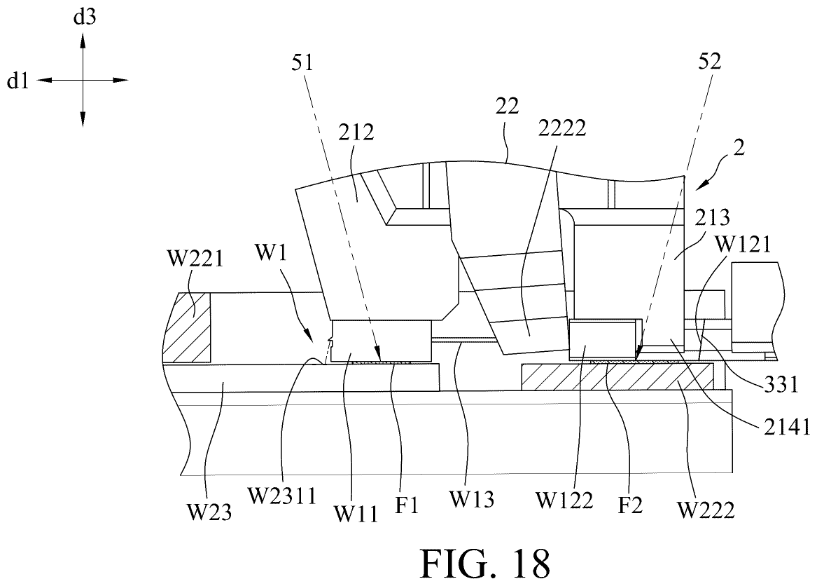

Referring to FIGS. 5, 6, and 18, the cure unit 5 includes two first cure assemblies 501 and a second cure assembly 502. The first cure assemblies 501 are spaced apart in the second direction (d2) and are respectively disposed above left and right sides of the retention member 21 in the second direction (d2). Each of the first cure assemblies 501 is operable to emit ultraviolet light 51 toward the first retention portion 212 of the retention member 21. The second cure assembly 502 is operable to output laser light 52 or hot air flow toward the second retention portion 213 of the retention member 21. In this embodiment, each of the first cure assemblies 501 includes an ultraviolet light source, and the second cure assembly 502 includes a laser light source and/or a hot air generator.

Referring to FIGS. 5 and 19, the retention mechanism (A) may be used in the component coupling device 902. The component coupling device 902 includes a machine bed (T), a first drive mechanism (B) disposed on the machine bed (T), a second drive mechanism (C) that is disposed on the first drive mechanism (B) and that is driven by the first drive mechanism (B) to move linearly in a plurality of directions, and an inspection mechanism (D) that is disposed on the first drive mechanism (B), that is driven by the first drive mechanism (B) to move linearly in a plurality of directions, and that is adapted for inspection of the integrated circuit component (W2) (see FIG. 1).

The retention mechanism (A) is disposed on the second drive mechanism (C) and is driven by the second drive mechanism (C) to rotate about a plurality of axes. The retention mechanism (A) is adapted to retain the optical fiber array unit (W1) and is driven by the first drive mechanism (B) and the second drive mechanism (C) to move linearly and rotate respectively, such that the optical fiber array unit (W1) is moved therewith linearly and rotated.

Specifically, the first drive mechanism (B) includes a first straight movement unit (B1) disposed on the machine bed (T), a second straight movement unit (B2) mounted to the first straight movement unit (B1), and a third straight movement unit (B3) mounted to the second straight movement unit (B2).

The first straight movement unit (B1) is operable to drive the second drive mechanism (C) to move linearly in the first direction (d1), and includes two first rail seats (B11) disposed on the machine bed (T) and spaced apart from each other in the second direction (d2) and two first slide seats (B12) disposed respectively on the first rail seats (B11). The first rail seats (B11) extend in the first direction (d1), and each of the first slide seats (B12) is movable along the respective one of the first rail seats (B11) in the first direction (d1). The second straight movement unit (B2) is operable to drive the second drive mechanism (C) to move linearly in the second direction (d2), and includes a second rail seat (B21) disposed across the first slide seats (B12), and a second slide seat (B22) mounted to the second rail seat (B21). The second rail seat (B21) extends in the second direction (d2), and the second slide seat (B22) is movable along the second rail seat (B21) in the second direction (d2). The third straight movement unit (B3) is operable to drive the second drive mechanism (C) to move linearly in the third direction (d3), and includes a third rail seat (B31) mounted to the second slide seat (B22) and a third slide seat (B32) mounted to the third rail seat (B31). The third rail seat (B31) extends in the third direction (d3), and the third slide seat (B32) is movable along the third rail seat (B31) in the third direction (d3).

In this way, one or more of the first straight movement unit (B1), the second straight movement unit (B2), and the third straight movement unit (B3) drives the second drive mechanism (C) to move linearly such that the retention mechanism (A) drives linear movements of the optical fiber array unit (W1) in one or more of the first direction (d1), the second direction (d2), and the third direction (d3).

In this embodiment, the first straight movement unit (B1) and the second straight movement unit (B2) employ linear motors to drive movements of the first slide seat (B12) and the second slide seat (B22), but the present disclosure is not limited thereto. In other embodiments, a combination of a screw rod and a rotary motor may be utilized to drive movement of the first slide seat (B12) and the second slide seat (B22). It should be noted that in this embodiment, the third straight movement unit (B3) drives movement of the third slide seat (B32) through a combination of a rotary motor and a screw rod, but the present disclosure is not limited thereto. For example, the third straight movement unit (B3) may drive movement of the third slide seat (B32) through a linear motor in other embodiments of the present disclosure.

The second drive mechanism (C) is operable to drive the retention mechanism (A) to rotate and thus rotate the optical fiber array unit (W1). Since the main feature of the present disclosure does not reside in how the second drive mechanism (C) drives the retention mechanism (A) to rotate, further details of the same are omitted for the sake of brevity.

The component coupling device 902 further includes a first stage (S1), a second stage (S2) spaced apart from the first stage (S1) in the second direction (d2), an adhesive coating device (S3) disposed at one side of the first stage (S1) that is opposite to the second stage (S2), and a detection device (S4) disposed between the first stage (S1) and the second stage (S2). The first stage (S1), the second stage (S2), the adhesive coating device (S3), and the detection device (S4) are all disposed on the machine bed (T).

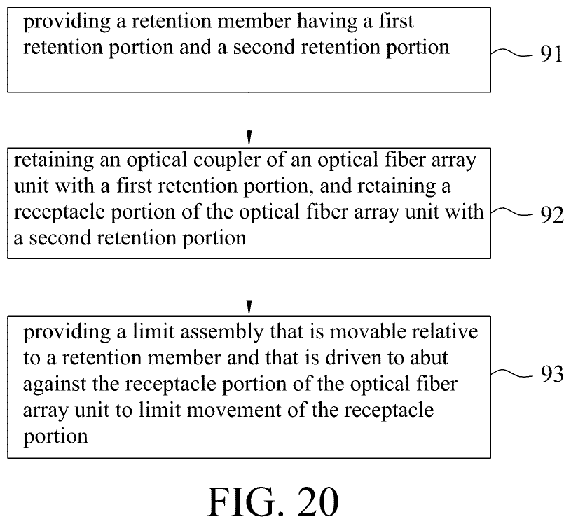

Referring to FIG. 20, a component retention method for retaining the optical fiber array unit (W1) (see FIG. 1) is implemented by the retention mechanism (A) of the first embodiment and includes the following steps.

In step 91, the retention member 21 having the first retention portion 212 and the second retention portion 213 is provided.

In step 92, the optical coupler (W11) of the optical fiber array unit (W1) is retained by the first retention portion 212. Specifically, the first retention portion 212 retains the optical coupler (W11) of the optical fiber array unit (W1), and the second retention portion 213 retains the receptacle portion (W12) of the optical fiber array unit (W1).

Referring to FIGS. 7, 16, and 19, first, the optical fiber array unit (W1) is placed on the first stage (S1), and the integrated circuit component (W2) is placed on the second stage (S2). Next, the retention mechanism (A) is driven to move to be disposed above the first stage (S1), and then the retention mechanism (A) is driven to move downwardly in the third direction (d3) until the retention component 2 comes into contact with the optical fiber array unit (W1) carried on the first stage (S1). At the same time, the negative pressure source is turned on such that the first retention portion 212 and the second retention portion 213 of the retention member 21 respectively suck the optical coupler (W11) and the receptacle portion (W12) of the optical fiber array unit (W1) to pick up the optical fiber array unit (W1).

In step 93, the limit assembly 22 is provided to be movable relative to the retention member 21 and is driven to abut against the receptacle portion (W12) of the optical fiber array unit (W1) to limit movement thereof. In step 93, the connector member 33 is also provided to be movable relative to the retention member 2, is driven to insert into the receptacle portion (W12) of the optical fiber array unit (W1), and is detachably connected to the optical fiber array unit (W1). In addition, the limit assembly 22 is driven to move relative to the retention member 21 when the connector member 33 is driven to move.

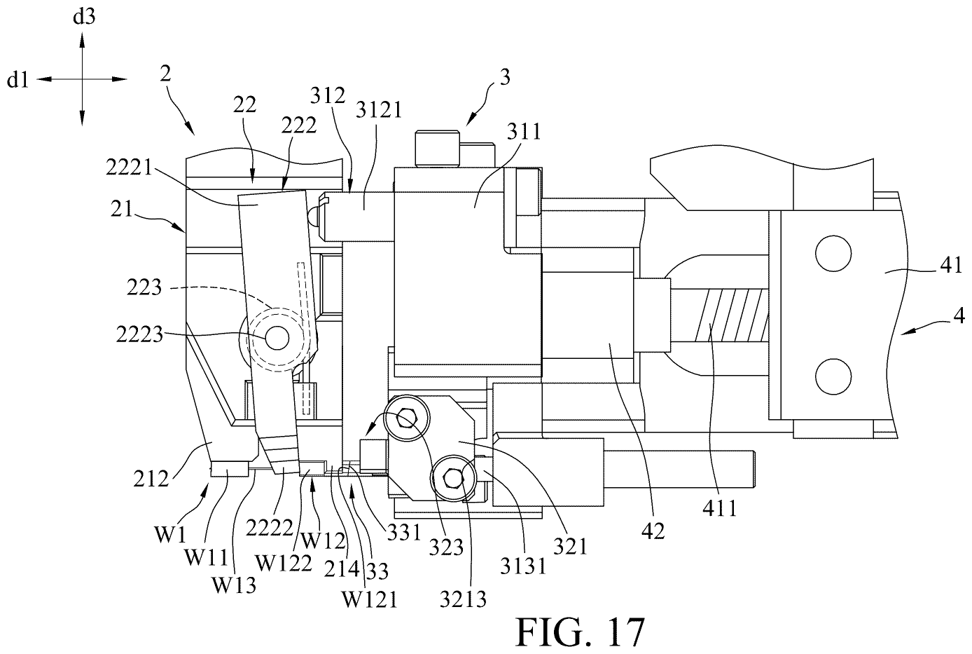

Referring to FIGS. 16 and 17, the telescopic rod 411 of the drive member 41 of the drive unit 4 is driven to extend forwardly in the first direction (d1), such that the movable member 42 and the connector unit 3 are moved forwardly in the first direction (d1) until the push members 3121 of the push assembly 312 of the connector unit 3 respectively push the driven ends 2221 of the limit members 222, such that the limit end 2222 of each of the limit members 222 pivots rearwardly about the pivot point 2223 of the corresponding one of the limit members 222, and thus abuts against the first seat portion (W122) of the receptacle portion (W12) of the optical fiber array unit (W1). In this way, movement of the receptacle portion (W12) in the first direction (d1) is limited since the first seat portion (W122) of the receptacle portion (W12) is clamped between the limit portion 214 and the limit ends 2222 of the limit members 222.

Referring to FIGS. 3 and 14, during the process in which the connector unit 3 is driven to move forwardly, the connector member 33 is also moved forwardly until the guide pins 3331 of the guiding portion 333 of the connector member 33 are inserted into the guide holes (W124) of the optical fiber array unit (W1). At this time, the abutment surface 331 of the connector member 33 abuts against the second side face (W121) of the receptacle portion (W12) and the light passage portion 332 corresponds in position to the optical fiber portion (W13) of the optical fiber array unit (W1). In this embodiment, the connector member 33 is inserted forwardly into the receptacle portion (W12), and the limit assembly 22 is pushed rearwardly against the receptacle portion (W12). That is to say, a direction of insertion movement of the connector member 33 into the receptacle portion (W12) is opposite to a direction of the limit assembly 22 in limiting the movement of the receptacle portion (W12).

In this embodiment, by virtue of the design of the push assembly 312, when the mount seat 31 is driven to move forwardly by the movable member 42, the driven ends 2221 of the limit members 222 are pushed by the push assembly 312 to pivot forwardly and the limit ends 2222 are pivoted rearwardly toward the limit portion 214 of the retention member 21.

During the process of the connector member 33 being driven to connect to the optical fiber array unit (W1), by virtue of the design of the first connecting unit 322 and the second connecting unit 324, the movable seat 32 may rotate relative to the mount seat 31 about the longitudinal axis, i.e., the first axial rod 3221, and may slightly move up and down in the third direction (d3) relative to the mount seat 31, and the second seat body 323 of the movable seat 32 may rotate relative to the first seat body 321 about the transverse axis. Thus, in a case where the guide pins 3331 are not precisely aligned with the guide holes (W124) in the first direction (d1), a position of the movable seat 32 may be adjusted and thus the guide pins 3331 of the connector member 33 are also adjusted to be aligned with the guide holes (W124) to be inserted therein precisely.

Referring to FIGS. 1 and 20, after the abovementioned steps 91 to 93 are performed, a coupling step and a curing step may be performed to couple the optical fiber array unit (W1) to the integrated circuit component (W2).

Referring to FIGS. 1, 2, and 19, in the coupling step, the retention mechanism (A) may be driven by the first drive mechanism (B) to move toward the adhesive coating device (S3) for coating adhesive. The adhesive coating device (S3) may coat the first adhesive (F1) and the second adhesive (F2) respectively on lower surfaces of the optical coupler (W11) and the receptacle portion (W12). After the first adhesive (F1) and the second adhesive (F2) are coated on the optical fiber array unit (W1), the retention mechanism (A) may be driven by the first drive mechanism (B) to move to be disposed above the second stage (S2). Then, the retention mechanism (A) may be driven by the first drive mechanism (B) and/or the second drive mechanism (C) to move downwardly in the third direction (d3) such that the lower surfaces of the optical coupler (W11) and the receptacle portion (W12) are respectively in contact with an upper surface of the photonic integrated circuit (W23) and an upper surface of the second cover portion (W222) of the cover unit (W22) respectively via the first adhesive (F1) and the second adhesive (F2). In this way, the optical signal (W3) may be transmitted between the optical fiber array unit (W1) and the integrated circuit component (W2) via the prism (W111) and the lens array (W231).

Before the optical fiber array unit (W1) is adhered to the integrated circuit component (W2) the inspection mechanism (D) obtains an inclination degree of the upper surface of the photonic integrated circuit (W23) by inspecting a distance between the inspection mechanism (D) and each of a plurality of points on the upper surface of the photonic integrated circuit (W23) using optical distance measurement or multi-point ranging techniques. After the optical fiber array unit (W1) is disposed on the integrated circuit component (W2), because the first adhesive (F1) and the second adhesive (F2) are not cured yet, the optical fiber array unit (W1) floats on the first adhesive (F1) and the second adhesive (F2) may be adjusted. Specifically, an inclination degree of the lower surface of the optical coupler (W11) and an orientation of the optical coupler (W11) and/or the prism (W111) may also be detected by the detection device (S4) that is disposed between the first stage (S1) and the second stage (S2) through, e.g., optical distance measurement or multi-point ranging techniques. In this way, when the retention mechanism (A) retains the optical fiber array unit (W1) to couple to the integrated circuit component (W2), the first drive mechanism (B) drives linear movement of the second drive mechanism (C) and thus movement of the retention mechanism (A) in the plurality of directions, and the second drive mechanism (C) drives rotational movement of the retention mechanism (A) about the plurality of axes, such that the orientation of the optical fiber array unit (W1) is registered with the orientation of the photonic integrated circuit (W23).

Referring to FIGS. 1, 2, 5, and 18, after the optical fiber array unit (W1) is adhered to the integrated circuit component (W2), the curing step may be performed to complete the coupling between the optical fiber array unit (W1) and the integrated circuit component (W2). The curing step is described below.

The cure unit 5 cures the first adhesive (F1) and the second adhesive (F2) respectively by the ultraviolet light 51 and the laser light 52 or hot air flow that are respectively outputted from the first cure assemblies 501 and second cure assembly 502. Since the optical coupler (W11) is made of a light-transmissive material, the ultraviolet light may propagate through the optical coupler (W11) and cure the first adhesive (F1) disposed between the optical coupler (W11) and the photonics integrated circuit (W23). In addition, since the laser light 52 is capable of generating heat, the second adhesive (F2) disposed between the receptacle portion (W12) and the second cover portion (W222) of the cover unit (W22) may be heated to be cured. Referring to FIGS. 2, 3, and 16, after the first adhesive (F1) and the second adhesive (F2) are cured, the drive unit 4 drives the connector member 3 to move away from the optical fiber array unit (W1), so the guide pins 3331 of the guiding portion 333 are drawn out from the guide holes (W124) of the receptacle portion (W12) of the optical fiber array unit (W1), and thus the connector member 3 is detached from the optical fiber array unit (W1).

When the connector unit 3 is driven by the drive unit 4 to move rearwardly in the first direction (d1) to be detached from the optical fiber array unit (W1), a frictional force between the guide pins 3331 and the guide holes (W124) may move the receptacle portion (W12) away from the optical coupler (W11). At this time, the structural design of the limit portion 214 of the retention member 21 may limit the movement of the receptacle portion (W12) rearwardly and thus the guide pins 3331 may be simply detached from the guide holes (W124).

After the connector unit 3 is detached from the optical fiber array unit (W1), the negative pressure source is turned off and the retention unit 2 does not retain the optical fiber array unit (W1), and then the optical fiber array unit (W1) may be moved away from the retention unit 2 to complete the process of coupling the optical fiber array unit (W1) to the integrated circuit component (W2).

Referring to FIGS. 1, 6, and 19, a predetermined number of the optical fiber array units (W1) may be sequentially coupled to the integrated circuit component (W2) by the first drive mechanism (B) and the second drive mechanism (C) of the component coupling device 902 that are driven to drive movement and rotation of the retention mechanism (A).

In the component retention method described above, since the connector member 33 that is connected to the measurement unit 901 is movable relative to the retention member 21, the connector member 33 is detachably connected to the optical fiber array unit (W1). In this way, the retention mechanism (A) not only retains the optical fiber array unit (W1) but is also beneficial to the measurement unit 901 in measuring the intensity of the optical signal (W3) transmitted back to the optical fiber array unit (W1).

In summary, by virtue of the retention mechanism (A) of the first embodiment according to the present disclosure, the structural design of the connector member 33 being movable relative to the retention member 21 enables the connector member 33 to be detachably connected to the optical fiber array unit (W1). Furthermore, the optical coupler (W11) and the receptacle portion (W12) of the optical fiber array unit (W1) are respectively retained by the first retention portion 212 and the second retention portion 213 of the retention member 21 that are spaced apart, and the optical fiber array unit (W1) may be stably retained by the retention member 21, thereby reducing a possibility that the optical fiber array unit (W1) falls off from the retention mechanism (A). Additionally, the structural design of the limit portion 214 prevents the receptacle portion (W12) from moving away from the optical coupler (W11) when the connector member 33 is detaching from the optical fiber array unit (W1). The structural design of the limit assembly 22 prevents the receptacle portion (W12) from moving towards the optical coupler (W11) when the connector member 33 is inserted into the optical fiber array unit (W1). In this way, the retention mechanism (A) and the component retention method of the first embodiment may stably retain the optical fiber array unit (W1) to be coupled to the integrated circuit component (W2).

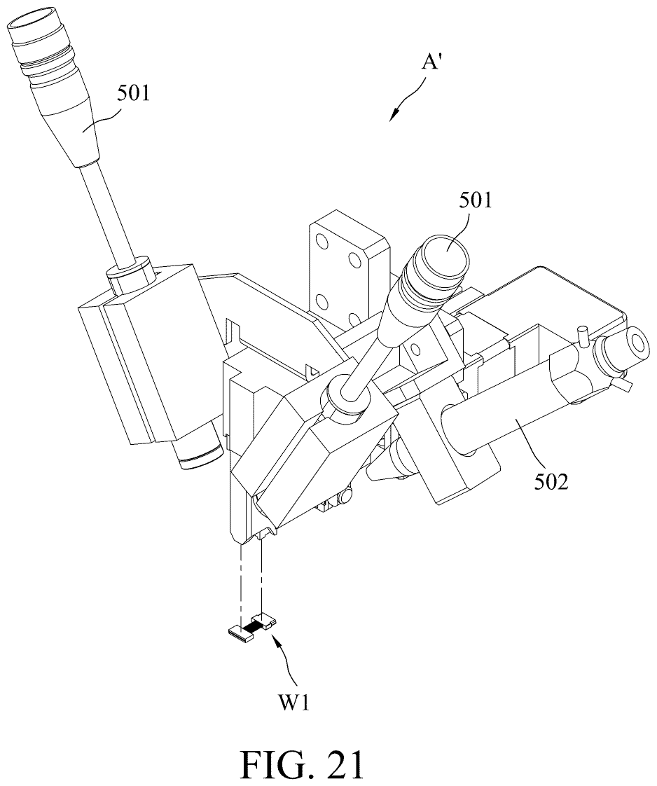

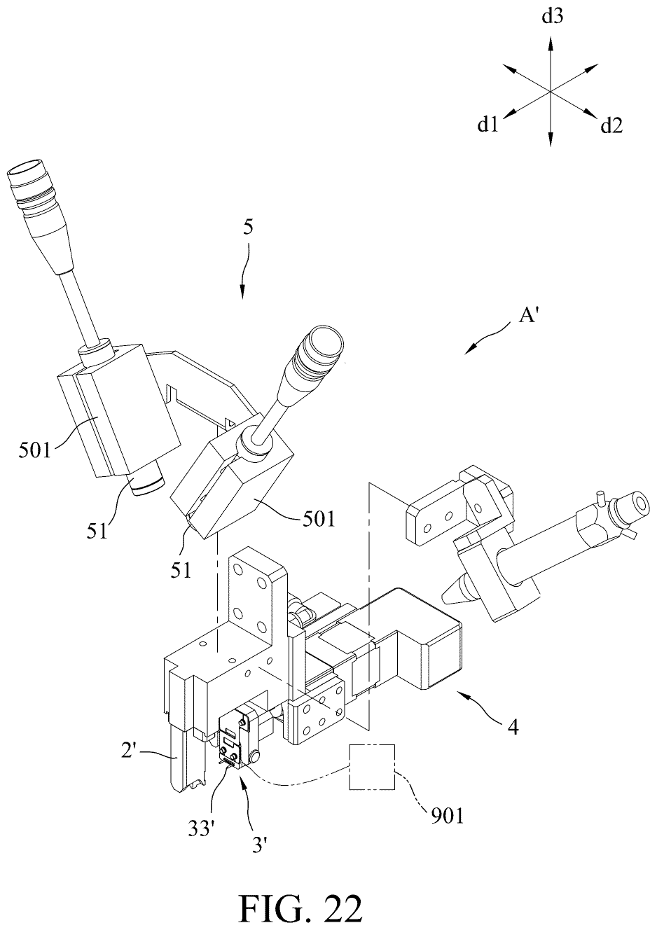

Referring to FIGS. 21 and 22, the retention mechanism (A′) of a second embodiment according to the present disclosure adapted for retaining the optical fiber array unit (W1) is shown. The main differences between the second embodiment and the first embodiment reside in the structure of the retention unit 2 and the connector unit 3 and are described in the following.

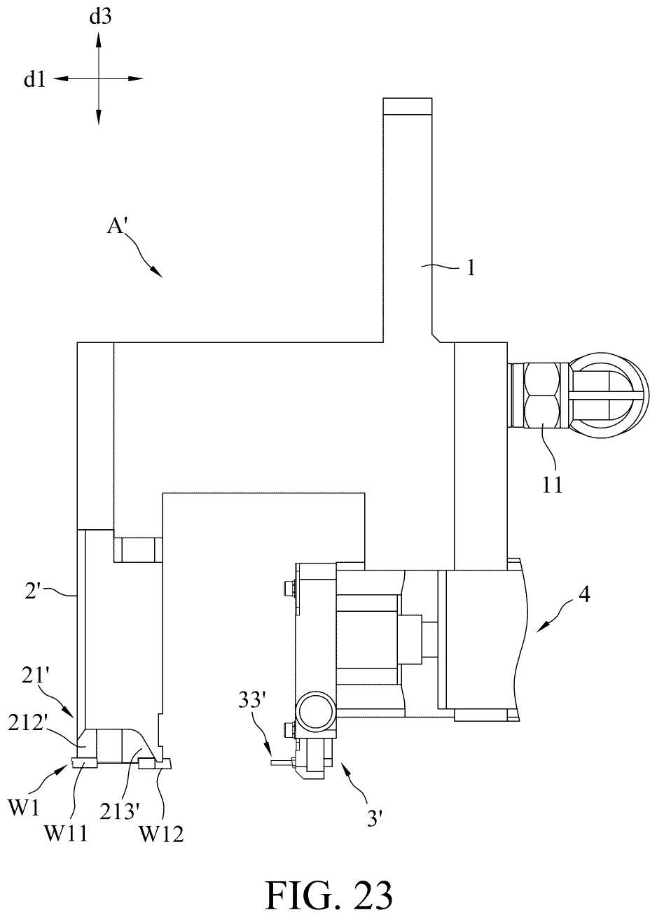

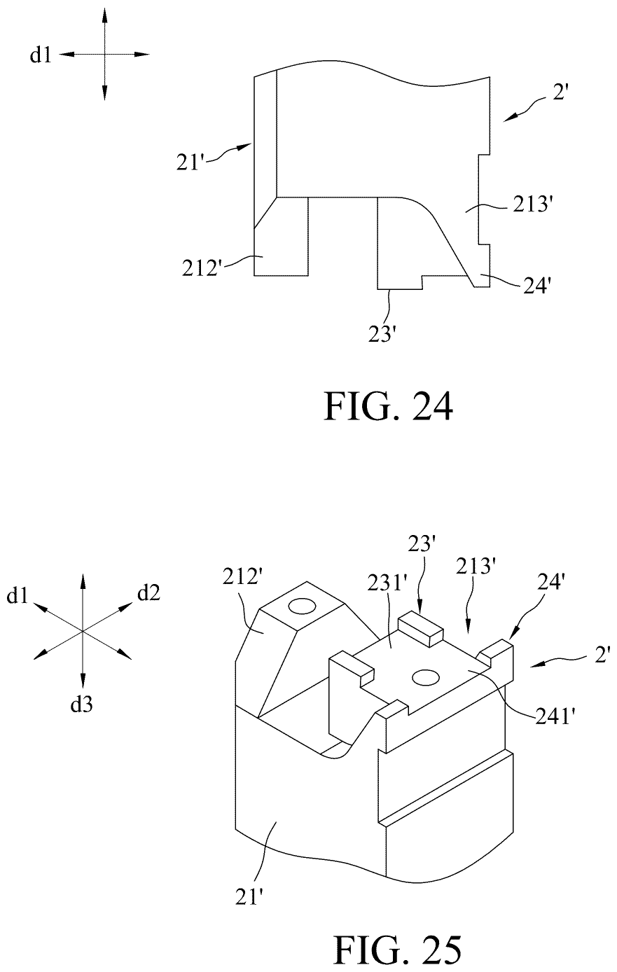

Further referring to FIGS. 23 to 25, in the second embodiment, the retention member 21′ of the retention unit 2′ of the retention mechanism (A′) includes a first retention portion 212′ and a second retention portion 213′ spaced apart from the first retention portion 212′ in the first direction (d1). The first retention portion 212′ is adapted for retaining the optical coupler (W11) of the optical fiber array unit (W1). The second retention portion 213′ is adapted for retaining the receptacle portion (W12) of the optical fiber array unit (W1). The retention member 21′ has a first limit portion 23′ and a second limit portion 24′. The first limit portion 23′ is disposed on one side of the second retention portion 213′ that is adjacent to the first retention portion 212′. The second limit portion 24′ is disposed on another side of the second retention portion 213′ away from the first retention portion 212′ in the first direction (d1) and has a width in the second direction (d2) greater than a width of the first limit portion 23′ in the second direction (d2). The first limit portion 23′ includes a first accommodating region 231′ adapted for the optical fiber portion (W13) of the optical fiber array unit (W1) to extend therethrough. The second limit portion 24′ includes a second accommodating region 241′ adapted for the second seat portion (W123) of the receptacle portion (W12) of the optical fiber array unit (W1) to extend therethrough. Further referring to FIG. 4, when the optical fiber array unit (W1) is retained by the retention member 21′, the first limit portion 23′ and the second limit portion 24′ are adapted to limit movement of the first seat portion (W122) of the receptacle portion (W12) that has the width in the second direction (d2) larger than the width of the second seat portion (W123) in the second direction (d2). In this way, the first limit portion 23′ and the second limit portion 24′ are adapted to limit movement of the fiber array member (W1) relative to the retention member 21′ in the first direction (d1).

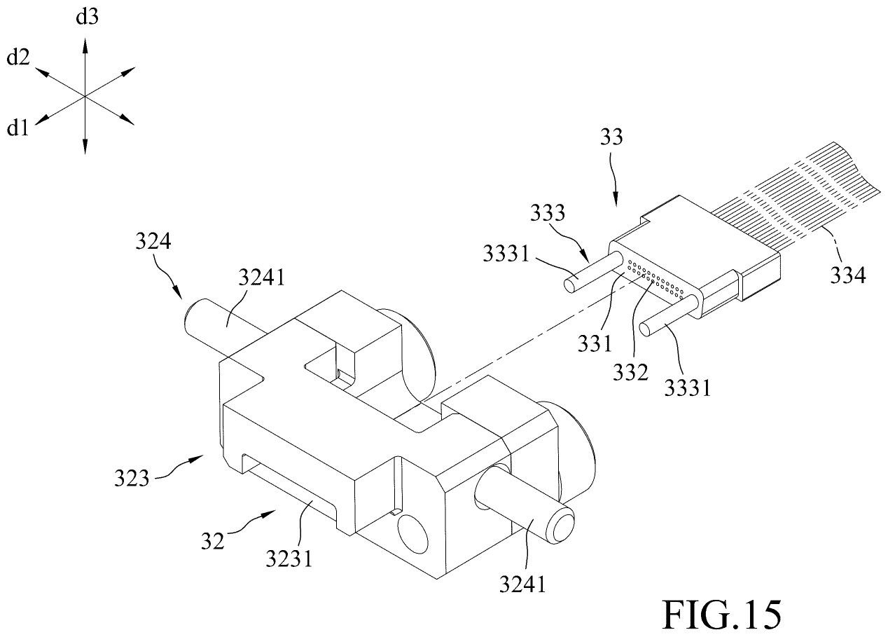

Referring to FIGS. 23, 26, and 27, the connector unit 3′ of the retention mechanism (A′) includes a mount seat 31′ connected to the movable member 42, a movable seat 32′ pivotally mounted on a lower portion of the mount seat 31′ and movable relative to the mount seat 31′, a connector member 33′ mounted securely to a lower portion of the movable seat 32′ and electrically connected to the measurement unit 901 (see FIG. 22), and a resilient member 34′. The connector member 33′ has a structure similar to that of the connector member 33 (see FIG. 15) of the first embodiment, is inserted into the movable seat 32′, and is driven by the movable seat 32′ to pivot therewith about another transverse axis (L1) that is parallel to the second direction (d2) when the mount seat 31′ is subjected to an external force exerted by the movable member 42. Specifically, an upper portion of the resilient member 34′ is mounted co-movably to the mount seat 31′, and a lower portion of the resilient member 34′ is mounted securely to the movable seat 32′. The resilient member 34′ may store an elastic restoring force when the mount seat 31′ is driven to move and thus the movable seat 32′ pivots, so that the connector member 33′ is driven to pivot with the movable seat 32′ and may return to its original position by the elastic restoring force. In this embodiment, the resilient member 34′ is, for example, a spring sheet.

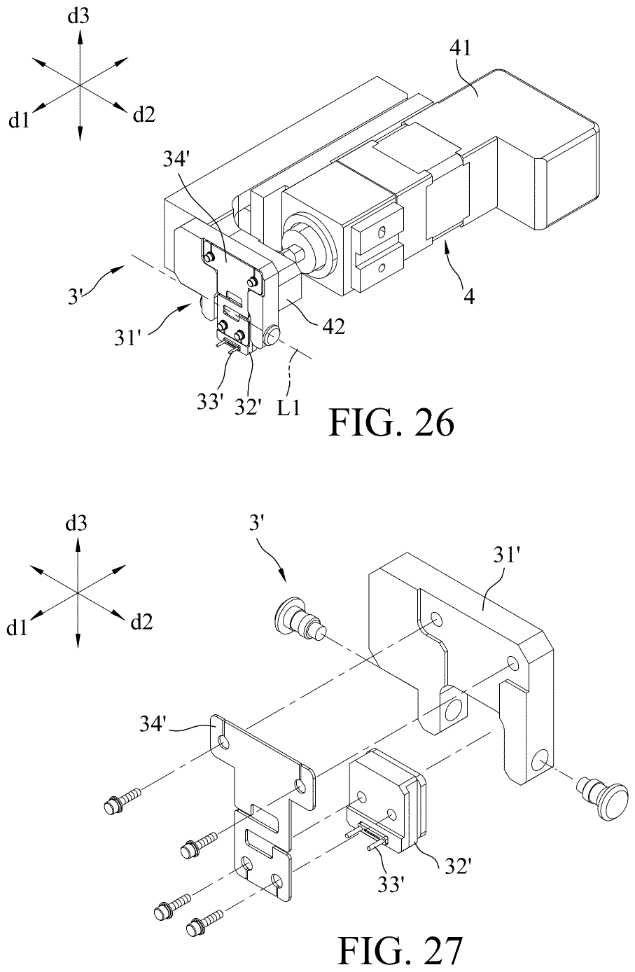

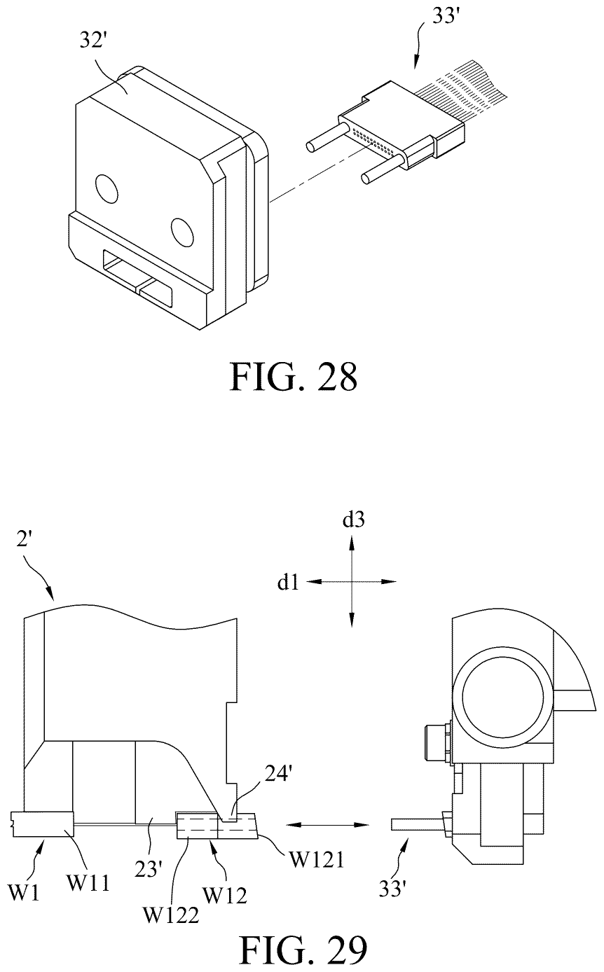

Referring to FIGS. 26 to 29, during the process of the connector member 33′ moving toward the optical fiber array unit (W1) to be connected thereto, the movable seat 32′ and the connector member 33′ are first driven to move such that the receptacle portion (W12) is pushed by the connector member 33′, and then the movable seat 32′ is pivoted slightly and rearwardly and the resilient member 34′ stores an elastic restoring force,. Subsequently, the movable eat 32′ and the connector member 33′ are restored to their original positions by the elastic restoring force of the resilient member 34′. By virtue of the first limit portion 23′ that is disposed between the receptacle portion (W12) and the optical coupler (W11), the first seat portion (W122) of the receptacle portion (W12) is blocked by the first limit portion 23′ and thus the receptacle portion (W12) is prevented from moving toward the optical coupler (W11).

When the connector member 33′ is detaching from the optical fiber array unit (W1), the movable seat 32′ and the connector member 33′ are first driven to move rearwardly, and then the moveable seat 32′ is pivoted slightly and the resilient member 34′ stores another restoring force. At this time, the receptacle portion (W12) may be driven by the connector member 33′ to move away from the optical coupler (W11). However, by virtue of the structural design of the second limit portion 24′ that is disposed between the first seat portion (W122) of the receptacle portion (W12) and the connector member 33′, the receptacle portion (W12) is blocked by the second limit portion 24′ and is thus prevented from being moved by the connector member 33′ away from the optical coupler (W11). After the connector member 33′ is detached from the optical fiber array unit (W1), the movable seat 32′ and the connector member 33′ are moved together by the another restoring force provided by the resilient member 34′ to return to their respective original positions.

As shown in FIGS. 22 and 23, the connector member 33 that is electrically connected to the measurement unit 901 is movable relative to the retention unit 2′, and is also adapted to be detachably connected to the optical fiber array unit (W1), thus the retention mechanism (A′) of the second embodiment of the present disclosure not only stably retains the optical fiber array unit (W1) to be coupled to the integrated circuit component (W2) (see FIG. 1) but is also beneficial to the measurement unit 901 in measuring the intensity of the optical signal (W3) transmitted back to the optical fiber array unit (W1).

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to lid various arrangements included within the spirit and scope of the broadest interpretation so as to encompass all such modifications and equivalent arrangements.

What is claimed is:

1. A retention mechanism adapted for retaining an optical fiber array unit, said retention mechanism comprising:
a retention unit that includes a retention member adapted for retaining the optical fiber array unit; and
a connector unit that includes a connector member adapted to be electrically connected to a measurement unit, movable relative to said retention member, and adapted to be detachably connected to the optical fiber array unit.

2. The retention mechanism as claimed in claim 1, wherein:
said retention mechanism further comprises a drive unit including a drive member and a movable member; and
said connector unit is mounted to said movable member and is driven by said drive member to move relative to said retention member.

3. The retention mechanism as claimed in claim 1, wherein:
said retention mechanism further comprises a support frame driven to move with said retention unit and said connector unit.

4. The retention mechanism as claimed in claim 1, the optical fiber array unit including an optical coupler and a receptacle portion, wherein:
said retention member has a first retention portion and a second retention portion spaced apart from said first retention portion;
said first retention portion has a first retention surface and a first negative pressure hole formed through said first retention surface;
said first retention surface is adapted to be in contact with the optical coupler of the optical fiber array unit for picking up the optical coupler through said first negative pressure hole;
said second retention portion has a second retention surface and a second negative pressure hole formed through said second retention surface; and
said second retention surface is adapted to be in contact with the receptacle portion of the optical fiber array unit for picking up the receptacle portion through said second negative pressure hole.

5. The retention mechanism as claimed in claim 4, wherein:
said retention member of said retention mechanism further has a limit portion adapted for limiting movement of the receptacle portion of the optical fiber array unit.

6. The retention mechanism as claimed in claim 5, wherein:
said limit portion is disposed at one side of said second retention portion that is opposite to said first retention portion; and
said retention member has an accommodation region defined by said limit portion and adapted for a portion of the receptacle portion to extend therethrough.

7. The retention mechanism as claimed in claim 5, wherein:
said retention mechanism further comprises a limit assembly movable relative to said retention member and including a limit end that is movable relative to said limit portion and that cooperates with said limit portion to limit the movement of the receptacle portion.

8. The retention mechanism as claimed in claim 7, wherein:
said limit assembly of said retention mechanism has said limit end, a driven end opposite to said limit end, and a pivot point disposed between said limit end and said driven end; and
said limit assembly is rotatably mounted to said retention member at said pivot point.

9. The retention mechanism as claimed in claim 8, wherein:
said connector unit further includes a mount seat including a push assembly; and
said mount seat is operable to move relative to said retention unit, such that said push assembly pushes said driven end of said limit assembly and thus said limit end of said limit assembly moves towards said limit portion.

10. The retention mechanism as claimed in claim 4, wherein:
said retention mechanism further comprises a cure unit including a first cure assembly that is operable to emit ultraviolet light toward said first retention portion of said retention member.

11. The retention mechanism as claimed in claim 10, wherein:
said cure unit further includes a second cure assembly that is operable to output one of laser light and hot air flow toward said second retention portion of said retention member.

12. The retention mechanism as claimed in claim 1, wherein:
said connector unit further includes a mount seat and a movable seat movable relative to said mount seat; and
said connector member is mounted to said movable seat.

13. The retention mechanism as claimed in claim 12, wherein said movable seat of said connector unit is movable along a longitudinal axis relative to said mount seat.

14. The retention mechanism as claimed in claim 12, wherein:
said movable seat of said connector unit has a pushed surface and is rotatable about a longitudinal axis relative to said mount seat; and
said mount seat includes a push assembly abutting against said pushed surface of said movable seat.

15. The retention mechanism as claimed in claim 12, wherein:
said movable seat of the connector unit has a first seat body and a second seat body pivotally mounted to said first seat body;
said first seat body is rotatable about a longitudinal axis relative to said mount seat;
said second seat body is co-rotatable with said first seat body and is pivotable about a transverse axis transverse to the longitudinal axis relative to said first seat body; and
said connector member of said connector unit is mounted to said second seat body of said movable seat.

16. The retention mechanism as claimed in claim 12, wherein:
said connector member includes an abutment surface facing said retention member, a light passage portion, and a guiding portion adapted to be inserted into the optical fiber array unit;
said light passage portion and said guiding portion are formed on said abutment surface; and
said guiding portion includes two guide pins spaced apart from each other and disposed on said light passage portion.
